(19) United States
(12) Patent Application Publication
(10) Pub. No.: US 2010/0153223 A1
(43) Pub. Date: Jun. 17, 2010

(54) METHOD AND SYSTEM FOR REGISTERING A CUSTOMER WITH AN ORGANIZATION

(76) Inventors: Gautam Bandyopadhyay, Bangalore (IN); Kiran K.S.R., Bangalore (IN)

Correspondence Address: MICHAEL BEST & FRIEDRICH LLP, 100 E WISCONSIN AVENUE, Suite 3300, MILWAUKEE, WI, 53202, US

(21) Appl. No.: 12/634,061

(22) Filed: Dec. 9, 2009

(30) Foreign Application Priority Data
Dec. 11, 2008 (IN) 3104/CHE/2008

(51) Int. Cl. G06Q 40/00; G06Q 30/00; G06F 15/16; G06Q 10/00

(52) U.S. Cl. 705/17; 705/35; 705/21; 709/204; 705/325

(57) ABSTRACT

The present invention discloses a method, system and computer program product for registering a customer with an organization to enable the customer to use various services through one or more delivery channels. Customer Relationship Information (CRI) and contact information of the customer is captured by the system. A confirmation number is communicated to the customer based on the validity of the CRI. The customer then submits the confirmation number to the system to complete the registration process. The registration is then confirmed based on the validity of the submitted confirmation number.

### BACKGROUND

The present invention relates to the field of electronic transactions. More specifically, it relates to a method and system for electronically registering a customer with an organization.

Presently, organizations such as banks and other financial institutions provide several value-added services to their registered customers. These services may include e-commerce services such as Internet banking, online payments, online transactions, online shopping, and so forth; online registration; mobile commerce; and so forth. Similarly, other organizations such as hotels and airlines also provide various services to their registered customers. These services may include online accommodation booking, online flight booking, online status checking, and the like. Such organizations provide these services through various delivery channels such as the Internet and mobile phones.

To avail such services, a customer needs to be registered with the organization. Various methods are available for registering the customer. Examples of such registration methods include manual registration, registration through the Internet, registration through an Interactive Voice Response (IVR) service, and the like.

Manual registration requires the customer to physically visit the organization and submit the required forms. The customer may not want to visit the organization to complete the registration process, since it consumes a significant amount of time and effort. Further, the customer may also need to carry various verification documents to the organization to complete the registration process which may also not be convenient for the customer. As a result, the customer may avoid registration to use the value added services.

Registration through IVR requires the customer to call a customer care executive of the organization and provide the required verification details on the phone. In some cases, it is possible that the customer executives of the organization is busy when the customer whishes to register with the organization. Further, the customer may not have all the required verification details during the conversation through the IVR and the customer may get confused.

In light of the discussion above, there is a need for an easily accessible and secure method for registering the customer with the organization. Further, the method should require minimum verification details from the customer to complete the registration process.

### SUMMARY

An object of the invention is to provide a method for registering a customer with an organization for availing one or more services through one or more delivery channels.

Another object of the invention is to register the customer with the organization through an Electronic Data Capture (EDC) device.

Yet another object of the invention is to provide a secure registration process for registering the customer with the organization for availing various services through various delivery channels.

To achieve the objectives mentioned above, the present invention provides a method, system and computer program product for registering a customer with an organization for availing various services through one or more delivery channels. The customer uses an identity apparatus provided by the organization and enters his or her contact information in an Electronic Data Capture (EDC) device. The EDC device reads Customer Relationship Information (CRI) contained in the identity apparatus. The CRI and the contact information of the customer are then captured by the system through the EDC device. Examples of the EDC device include an Automatic Teller Machine (ATM) and an electronic Point of Sale (POS) terminal. The electronic POS may be located at a merchant location. The system fetches verification data corresponding to the customer from a server of the organization. The system then matches the captured CRI with the fetched verification data. Based on the validity of the CRI, the system generates a confirmation number. The confirmation number is then communicated to the customer. Thereafter, the customer enters the confirmation number and a Personal Identification Number (PIN) in the EDC device to complete the registration process. Thereafter, the system confirms the registration if the confirmation number and the PIN are valid. Further, the system sends an acknowledgement message to the customer about the confirmation of the registration. The system may also store information related to the registration of the customer.

The method and system described above have a number of advantages. The registration is performed through EDC devices located at widely spread merchant locations. Therefore, the proposed registration method reduces the entry barrier for the introduction of new services by the organization. The method is secure since the confirmation of the registration is based on the validity of a unique customer PIN and the confirmation number. Further, the customer does not need to visit the organization for registration since the registration is performed through EDC devices spread across various merchant locations. Furthermore, the customer needs to enter only his/her Personal Identification Number (PIN) and contact information to complete the registration process.

### BRIEF DESCRIPTION OF THE DRAWINGS

The various embodiments of the invention will hereinafter be described in conjunction with the appended drawings, provided to illustrate and not to limit the invention, wherein like designations denote like elements, and in which:

FIG. 1 illustrates an environment in which various embodiments of the present invention may be practiced;

FIG. 2 is a flowchart of a method for registering a customer with an organization for enabling the customer to avail one or more services through one or more delivery channels, in accordance with an embodiment of the invention;

FIGS. 3a, 3b and 3c is a flowchart of a method for registering a customer with the organization to enable the customer to avail one or more services through one or more delivery channels, in accordance with another embodiment of the invention; and

FIG. 4 is a block diagram of a system for registering the customer with the organization to enable the customer to use the services through alternate delivery channels, in accordance with an embodiment of the invention.

### DETAILED DESCRIPTION OF THE DRAWINGS

The invention describes a method, system and computer program product for registering a customer with an organization to enable the customer to avail one or more services through one or more delivery channels. The customer uses an identity apparatus in an Electronic Data Capture (EDC) device to register with the organization. Thereafter, Customer Relationship Information (CRI) and contact information of the customer is captured by the system through the EDC device. Thereafter, a confirmation number is communicated to the customer based on the validity of the CRI. The customer then submits the confirmation number to the system to complete the registration process. The registration is confirmed based on the validity of the submitted confirmation number. According to another embodiment of the invention, the registration is confirmed based on the validity of both the submitted confirmation number as well as a Personal Identification Number (PIN) of the customer.

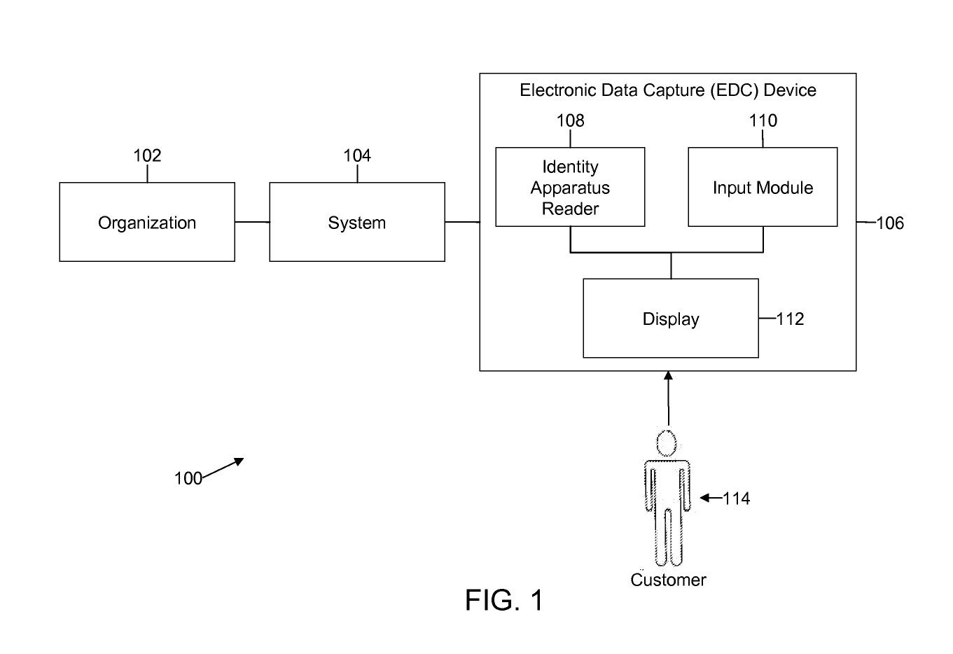

FIG. 1 illustrates an environment 100 in which various embodiments of the present invention may be practiced. Environment 100 includes one or more organizations such as an organization 102, a system 104, an Electronic Data Capture (EDC) device 106, and a customer 114. EDC device 106 includes an identity apparatus reader 108, an input module 110, and a display 112.

Various examples of organization 102 may include, but are not limited to, organizations such as banks, hotels, airlines, financial institutions, and similar companies that provide value-added services to customers. Organization 102 provides one or more services to customer 114 through various delivery channels. In an embodiment of the invention, customer 114 is already registered with organization 102 for availing the value-added services through a delivery channel. For example, customer 114 uses an online banking service provided by a bank through a delivery channel such as the Internet.

As is known in the art, organization 102 provides an identity apparatus to customer 114 for authenticating customer 114 for various services. Various examples of the identity apparatus may include, but are not limited to, a magnetic strip card such as a debit card, a credit card, and an ATM card; a contactless card such as a card containing Radio Frequency Identification (RFID) tag; a smart card; a physical card and the like. Further, organization 102 provides a unique Personal Identification Number (PIN) to customer 114 corresponding to the identity apparatus to authenticate customer 114. Customer 114 uses the PIN along with the identity apparatus to perform various transactions. The identity apparatus includes the Customer Relationship Information (CRI) of customer 114. Further, organization 102 may use one or more servers to store the information corresponding to the registered customers such as customer 114. This registration is hereinafter referred to as initial registration. The verification data corresponding to the customer is stored on the server of organization 102 at the time of the initial registration. Further, in an embodiment of the invention, the server may validate the PIN to authenticate customer 114 to perform various transactions.

When organization 102 introduces a new service, for example, mobile commerce which enables customer 114 to use the services provided by organization 102 through an alternate delivery channel, customer 114 may be required to register again with organization 102 to use the new service. The alternate delivery channel may be a mobile communication network.

The present invention discloses a method for registering customer 114 to enable customer 114 to avail various services provided by organization 102 through another delivery channels. For example, if customer 114 is initially registered with organization 102 for availing services through the Internet, then the present invention provides a method for registering customer 114 for using new services provided by organization 102 through the alternate delivery channel such as the mobile communication network by using a mobile phone.

In accordance with various embodiments of the invention, the registration is performed through EDC device 106. Examples of EDC device 106 include, but are not limited to, an Automatic Teller Machine (ATM) and an electronic Point of Sale (POS) terminal. Electronic POS terminals are generally located at various merchant locations. Identity apparatus reader 108 reads the CRI contained in the identity apparatus of the customer. Examples of identity apparatus reader 108 include, but are not limited to, a magnetic card reader, an optical scanner, an electronic memory reader, and the like. Input module 110 is used by customer 114 for inputting various data. Display 112 provides a graphical user interface to customer 114.

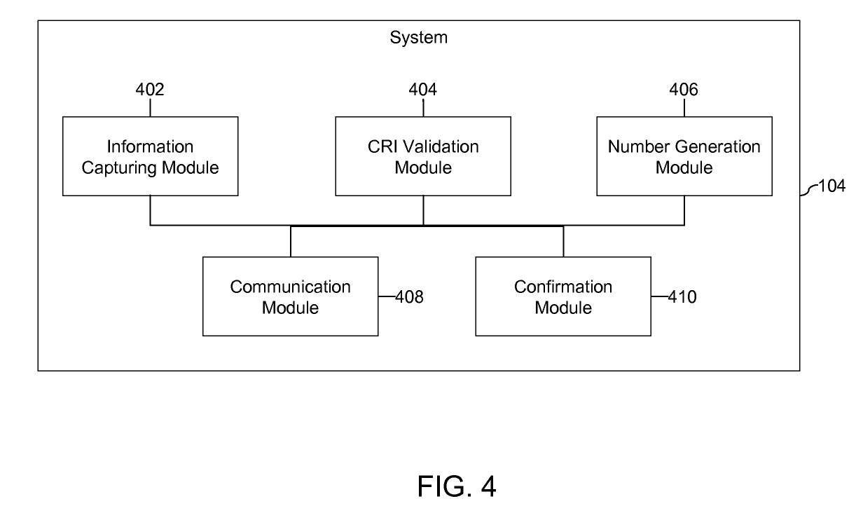

Customer 114 may use the nearest EDC device 106 to register with organization 102 in order to avail one or more services through the alternate delivery channel such as the mobile communication network. Customer 114 uses the identity apparatus in identity apparatus reader 108 and enters customer-specific information for the registration through input module 110. System 104 confirms the registration of customer 114 based on the validity of the information captured by identity apparatus reader 108 and the entered customer-specific information. Various messages indicating the status of the registration are displayed on display 112. System 104 is explained in detail in conjunction with FIG. 4.

The CRI may include, but is not limited to, a name of customer 114, an account number of customer 114, a customer identifier, an expiration date of the identity apparatus, a PIN Verification Value (PVV), a PIN Verification Key Indicator (PVKI), a Card Verification Value (CW), a Card Validation Code (CVC), and the like.

Similarly, the verification data may include, but is not limited to, the name of customer 114, the account number of customer 114, the customer identifier, the expiration date of the identity apparatus, the PVV, the PVKI, the CVV, the CVC, a copy of the PIN provided to customer 114, and the like.

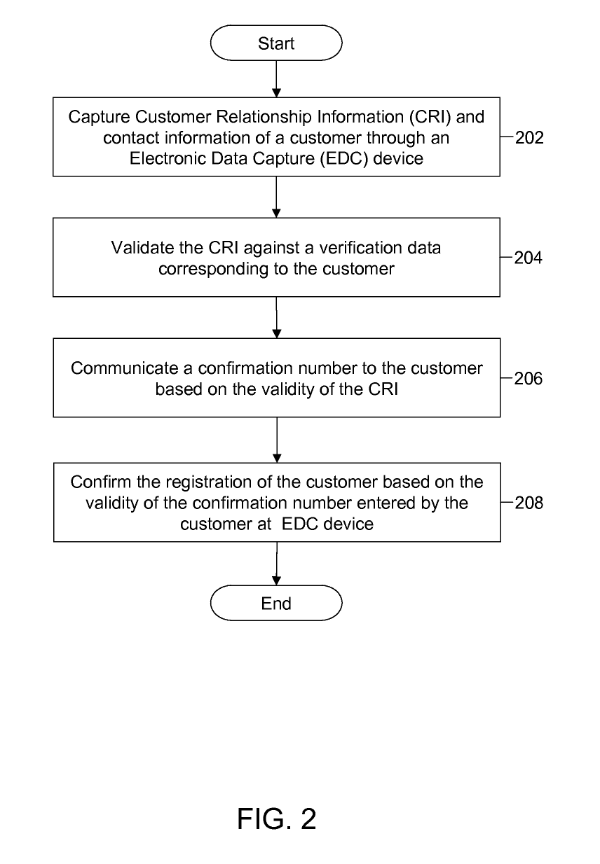

FIG. 2 is a flowchart of a method for registering a customer, such as, customer 114 with an organization, such as, organization 102 for enabling the customer to avail one or more services through one or more delivery channels, in accordance with an embodiment of the invention.

When the customer wants to register with the organization to avail various services through an alternate delivery channel, the customer uses an identity apparatus in an Electronic Data Capture (EDC) device, such as, EDC device 106. The customer then enters corresponding contact information in the EDC device. The contact information may include, but is not limited to, a mobile phone number of the customer, an email address of the customer, and the like. The identity apparatus contains Customer Relationship Information (CRI), which is read by the EDC device. At 202, the CRI and the contact information of the customer are captured by a registration system, such as, system 104, through the EDC device.

At 204, the CRI is validated against verification data corresponding to the customer. In an embodiment of the present invention, the verification data may be stored on the server of the organization at the time of the initial registration. If the CRI is valid, a confirmation number is generated. Thereafter, at 206, the confirmation number is communicated to the customer. However, if the CRI is invalid, an error message is displayed on a display screen such as display 112 of the EDC device.

In an embodiment of the invention, the confirmation number may be electronically communicated to the EDC device. Further, the confirmation number may be displayed on the display screen of the EDC device.

In another embodiment of the invention, the confirmation number is electronically communicated to the contact information provided by the customer. For example, the confirmation number may be communicated to the customer through an email, an SMS or an automated voice call.

In yet another embodiment of the invention, the confirmation number is electronically communicated to the EDC device as well as the contact information provided by the user.

After receiving the confirmation number, the customer enters the confirmation number in the EDC device to complete the registration process. The validity of the entered confirmation number is checked against the generated confirmation number. If the entered confirmation number matches with the generated confirmation number, then, at 208, the registration of the user is confirmed. If the confirmation number is invalid, then an error message is displayed on the display screen.

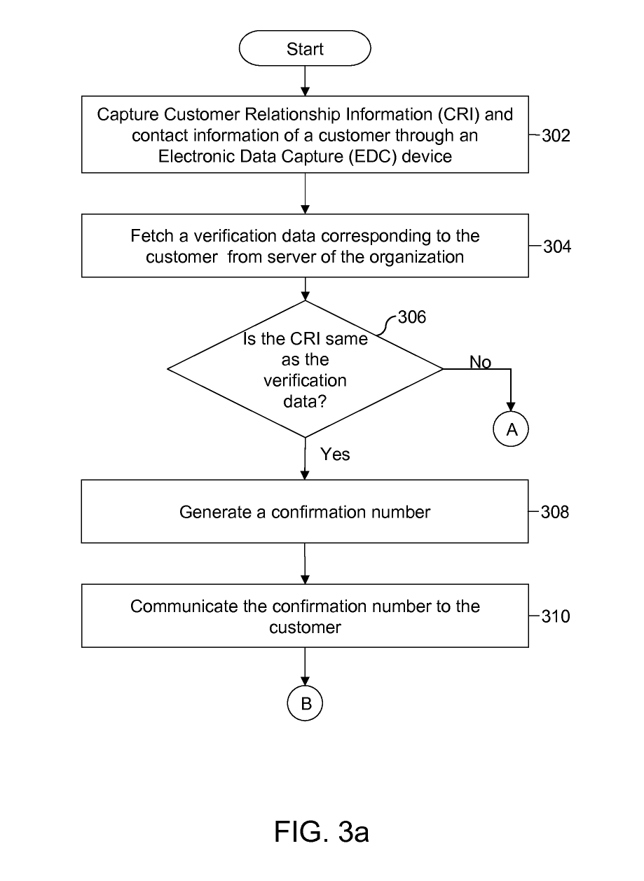

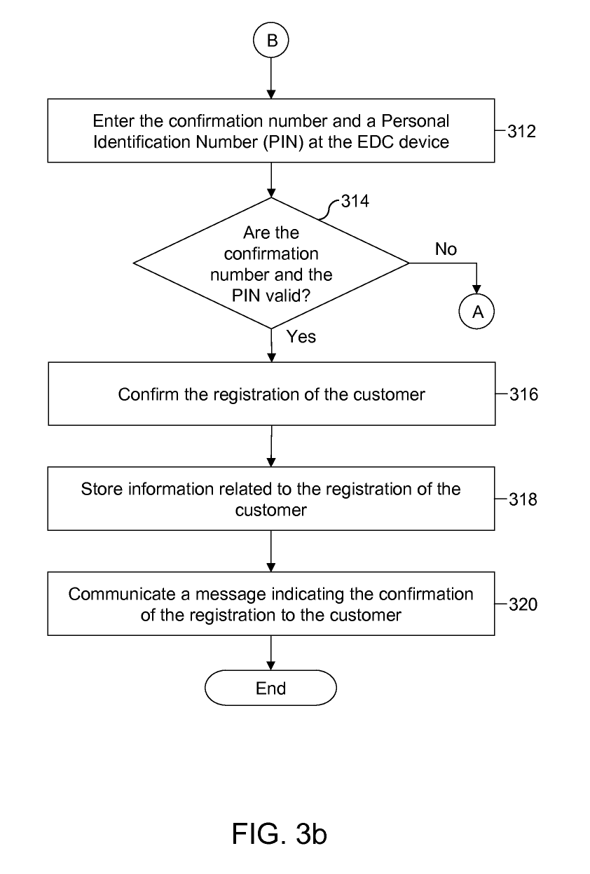

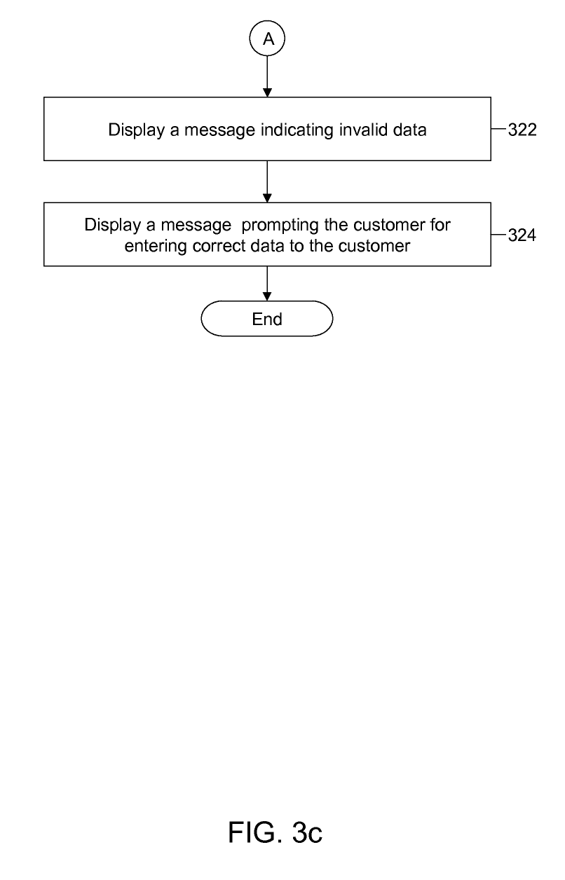

FIGS. 3a, 3b and 3c is a flowchart of a method for registering a customer, such as, customer 114 with an organization, such as, organization 102 to enable the customer to avail one or more services through one or more delivery channels, in accordance with another embodiment of the invention.

When the customer wants to register with the organization in order to avail various services through an alternate delivery channel, the customer uses an identity apparatus in an Electronic Data Capture (EDC) device, such as, EDC device 106. The customer then enters corresponding contact information at the EDC device. The contact information may include, but is not limited to, a mobile phone number of the customer, an email address of the customer, and the like. The identity apparatus contains Customer Relationship Information (CRI), which is read by the EDC device. At 302, the CRI and the contact information of the customer are captured by a registration system, such as, system 104, through the EDC device.

At 304, verification data corresponding to the customer is fetched by the registration system from a server of the organization. The verification data is stored on the server of the organization at the time of the initial registration.

At 306, the CRI is compared with the fetched verification data corresponding to the customer. If the CRI does not match with the verification data, then, at 322, an error message indicating invalid data is displayed on a display screen such as display 112 of the EDC device. Thereafter, at 324, a message prompting the user to use a correct identity apparatus may be displayed on the display screen of the EDC device.

If the CRI matches with the verification data, then, at 308, a confirmation number is generated. The confirmation number may be a random unique number generated using various techniques known in the art.

At 310, the confirmation number is communicated to the customer to authenticate the customer. Further, various embodiments of communicating the confirmation number to the customer have been explained in detail in conjunction with FIG. 2.

At 312, the customer enters the received confirmation number and a Personal Identification Number (PIN) in the EDC device to complete the registration process. Thereafter, at 314, the entered confirmation number is matched with the generated confirmation number by the registration system to check the validity of the entered confirmation number. A validation result of the PIN is then obtained by the registration system from the server. If at least one of the confirmation number and the PIN does not match with the generated confirmation number and a copy of the PIN, respectively, an error message is displayed on the display screen of the EDC device at 322. Further, at 324, a message prompting the customer to enter the correct confirmation number or the correct PIN may be displayed on the display screen of the EDC device.

If the confirmation number and the PIN are valid, then, at 316, the registration of the customer is confirmed. At 318, information related to the registration of the customer is stored on the registration system. The stored information includes the date of registration, a billing address, the contact information of the customer, and the CRI. The stored information may be used by the registration system for authenticating the customer during future transactions. At 320, a message indicating the confirmation of the registration is communicated to the customer.

In an embodiment of the invention, the confirmation message may be electronically communicated to the EDC device. The message may then be displayed on the display screen of the EDC device.

In accordance with another embodiment of the invention, the confirmation message may be electronically communicated to the contact information provided by the customer. For example, the confirmation message may be communicated to the customer through an email, an SMS or an automated voice call.

In yet another embodiment of the invention, the message indicating the confirmation of the registration may be displayed on the display screen of the EDC device and also communicated to the contact information of the customer.

The user is now allowed to use the alternate delivery channel, such as a mobile phone, for availing various services.

At 322, a message indicating invalid data is displayed on the display screen, if at least one of the CRI, the confirmation number and the PIN is invalid. For example, a message, for example, ‘Invalid Confirmation Number’, may be displayed if the confirmation number entered by the customer is invalid. Similarly, a message, for example, ‘Invalid PIN’, may be displayed if the PIN entered by the customer is invalid.

At 324, a message prompting the customer to enter the correct data is displayed on the display screen. For example, if the confirmation number entered by the customer is invalid, then a message prompting the customer to enter the correct confirmation number may be displayed on the display screen of the EDC device. The message may be ‘Input Correct Confirmation Number’. Similarly, if the PIN entered by the customer is invalid, then a message, for example, ‘Input Correct Pin’, may be displayed on the display screen of the EDC device. Furthermore, if the captured CRI is invalid, then a message prompting the customer to use a correct identity apparatus may be displayed on the display screen of the EDC device.

FIG. 4 is a block diagram of system 104 for registering customer 114 with organization 102 to enable the customer to use the services through alternate delivery channels, in accordance with an embodiment of the invention. System 104 includes an information capturing module 402, a Customer Relationship Information (CRI) validation module 404, a number generation module 406, a communication module 408, and a confirmation module 410.

Customer 114 uses an identity apparatus in EDC device 106 when customer 114 wants to register with organization 102 for availing various services through an alternate delivery channel, such as a mobile communication network using a mobile phone. Further, customer 114 also enters his/her contact information in EDC device 106 through input module 110. The contact information may include, but is not limited to, an email address, a mobile phone number, and the like. The CRI is read by identity apparatus reader 108. Thereafter, information capturing module 402 captures the CRI and the contact information through EDC device 106. Information capturing module 402 also fetches verification data corresponding to customer 114 from a server of organization 102.

CRI validation module 404 validates the captured CRI against the fetched verification data. CRI validation module 404 compares the captured CRI with the verification data corresponding to customer 114. As discussed above, the verification data is stored on the server of organization 102.

Number generation module 406 generates a confirmation number based on the comparison between the CRI and the verification data. If the CRI matches with the verification data, then the confirmation number is generated. Otherwise, an error message indicating invalid data may be displayed on display 112. The confirmation number is a unique random number generated using techniques known in the art.

Communication module 408 electronically communicates the confirmation number and one or more messages indicating the current status of the registration.

Confirmation module 410 confirms the registration of customer 114 based on the validity of the confirmation number. To complete the registration process, customer 114 enters the confirmation number and a Personal Identification Number (PIN) in EDC device 106 through input module 110. Confirmation module 410 matches the confirmation number entered by customer 114 with the generated confirmation number. If the confirmation number entered by customer 114 matches with the generated confirmation number, then the registration is confirmed. If the confirmation number is invalid, then confirmation module 410 sends a message indicating invalid confirmation number to the customer through communication module 408. Confirmation module 410 communicates a message to customer 114 to acknowledge the confirmation of the registration through communication module 408. Further, various embodiments for communicating the confirmation number, messages indicating the status of the registration, and the message indicating the confirmation have been explained in detail in conjunction with FIG. 2 and FIG. 3.

In accordance with another embodiment, confirmation module 410 confirms the registration based on the validity of both the confirmation number as well as the PIN.

In accordance with an embodiment of the invention, confirmation module 410 stores information related to the confirmation of the registration. The information includes the date of registration, a billing address, the contact information of customer 114, and the CRI.

In an exemplary embodiment of the invention, a customer such as customer 114 uses a magnetic strip card, such as a debit card, a credit card or an ATM card, provided by a bank to register with the bank for using various mobile commerce services. The customer uses the magnetic strip card on an ATM and selects an option to register for mobile commerce services. The customer then enters his/her contact information, such as a mobile phone number or an email address, in the ATM. The ATM then reads Customer Relationship Information (CRI) from the magnetic strip card, and subsequently, the CRI and the contact information are captured by a registration system such as system 104. The registration system then fetches the verification data from the server of the bank. Thereafter, the CRI is matched with the fetched verification data and a unique confirmation number is generated based on the validity of the CRI. If the CRI is invalid, then an error message, for example, ‘Invalid Card’, may be displayed on the display screen of the ATM. Further, another message may also be displayed on the display screen of the ATM prompting the customer to use a valid card.

If the CRI is valid, the confirmation number is communicated to the customer through an SMS, an automated call or an auto generated email. Thereafter, the customer enters the received confirmation number and a PIN corresponding to the magnetic strip card in the ATM to complete the registration process.

The registration system then checks the validity of the entered confirmation number. Further, the validity of the PIN may be checked by the server of the bank. The registration system confirms the registration if the confirmation number as well as the PIN entered by the customer are valid. Error messages, for example, ‘Invalid Confirmation Number’ and ‘Invalid PIN’, may be displayed on the display screen of the ATM if the confirmation number and the PIN are invalid.

After the confirmation of the registration, the registration system sends a confirmation message to the customer through an SMS or an auto generated email to acknowledge the confirmation of the registration.

Similarly, in another exemplary embodiment of the invention, the customer may use a magnetic strip card at an electronic POS terminal located at a merchant location. The customer may enter his/her contact information, the confirmation number and the PIN at the electronic POS terminal. Further, as explained above, various messages indicating the status of the registration may be displayed on a display screen of the electronic POS terminal.

The method and system described above have a number of advantages. The registration is performed through EDC devices located at widely spread merchant locations. Therefore, the proposed registration method reduces the entry barrier for the introduction of new services. The method is also secure since the confirmation of the registration is based on the validity of a unique customer PIN and the confirmation number. Further, the customer does not need to visit the organization for registration since the registration is performed through EDC devices spread across several merchant locations. Furthermore, the customer needs to enter only his/her Personal Identification Number (PIN) and contact information to complete the registration process.

The system for registering a customer with an organization, as described in the present invention or any of its components, may be embodied in the form of a computer system. Typical examples of a computer system include a general-purpose computer, a programmed microprocessor, a micro-controller, a peripheral integrated circuit element, and other devices or arrangements of devices that are capable of implementing the steps that constitute the method of the present invention.

The computer system comprises a computer, an input device, a display unit and the Internet. The computer further comprises a microprocessor, which is connected to a communication bus. The computer also includes a memory, which may include Random Access Memory (RAM) and Read Only Memory (ROM). The computer system also comprises a storage device, which can be a hard disk drive or a removable storage drive such as a floppy disk drive, an optical disk drive, etc. The storage device can also be other similar means for loading computer programs or other instructions into the computer system. The computer system also includes a communication unit, which enables the computer to connect to other databases and the Internet through an Input/Output (I/O) interface. The communication unit also enables the transfer as well as reception of data from other databases. The communication unit may include a modem, an Ethernet card, or any similar device which enable the computer system to connect to databases and networks such as Local Area Network (LAN), Metropolitan Area Network (MAN), Wide Area Network (WAN) and the Internet. The computer system facilitates inputs from a user through an input device, accessible to the system through an I/O interface.

The computer system executes a set of instructions that are stored in one or more storage elements, in order to process the input data. The storage elements may also hold data or other information as desired. The storage element may be in the form of an information source or a physical memory element present in the processing machine.

The present invention may also be embodied in a computer program product for registering a customer with an organization. The computer program product includes a computer usable medium having a set program instructions comprising a program code for registering a customer with an organization. The set of instructions may include various commands that instruct the processing machine to perform specific tasks such as the steps that constitute the method of the present invention. The set of instructions may be in the form of a software program. Further, the software may be in the form of a collection of separate programs, a program module with a large program or a portion of a program module, as in the present invention. The software may also include modular programming in the form of object-oriented programming. The processing of input data by the processing machine may be in response to user commands, results of previous processing or a request made by another processing machine.

While the preferred embodiments of the invention have been illustrated and described, it will be clear that the invention is not limited to these embodiments only. Numerous modifications, changes, variations, substitutions and equivalents will be apparent to those skilled in the art without departing from the spirit and scope of the invention, as described in the claims.

What is claimed is:

1. A method for registering a customer with an organization for enabling the customer to avail one or more services through one or more delivery channels, the method comprising:
a. capturing Customer Relationship Information (CRI) and contact information of the customer through an Electronic Data Capture (EDC) device, the CRI being associated with an identity apparatus issued to the customer by the organization;
b. validating the CRI against a verification data corresponding to the customer, the verification data being stored at a server of the organization;
c. communicating a confirmation number to the customer if the CRI is valid, the confirmation number being communicated by the organization for authenticating the customer; and
d. confirming the registration of the customer if the confirmation number is valid, wherein the confirmation number is entered by the customer at the EDC device.

2. The method according to claim 1, wherein the EDC device is at least one of an electronic Point of Sale (POS) terminal and an Automatic Teller Machine (ATM).

3. The method according to claim 1, wherein the CRI includes at least one of a name of the customer, an account number of the customer, a customer identifier, an expiration date of the identity apparatus, a Personal Identification Number (PIN) Verification Value (PW), a PIN Verification Key Indicator (PVKI), a Card Verification Value (CVV) and a Card Validation Code (CVC).

4. The method according to claim 1, wherein the confirmation number is electronically communicated to the customer.

5. The method according to claim 1, wherein the contact information is at least one of a mobile phone number and an email address of the customer.

6. The method according to claim 1 further comprising displaying a plurality of messages indicating a current status of the registration, wherein the plurality of messages is displayed on the EDC device.

7. The method according to claim 1, wherein confirming the registration of the customer further comprises:
a. entering a Personal Identification Number (PIN), the PIN being entered by the customer at the EDC device, wherein the PIN is provided to the customer by the organization for verifying the customer; and
b. validating the PIN at the server of the organization.

8. The method according to claim 1 further comprising storing information corresponding to the registration of the customer, wherein the information includes at least one of the date of the registration, a billing address, the contact information of the customer and the CRI.

9. The method according to claim 1, wherein confirming the registration of the customer comprises electronically communicating a message indicating the confirmation of the registration to the customer.

10. A system for registering a customer with an organization for enabling the customer to avail one or more services through one or more delivery channels, the system comprising:
a. an information capturing module configured for capturing Customer Relationship Information (CRI) and a contact information of the customer through an Electronic Data Capture (EDC) device, the CRI being associated with an identity apparatus issued to the customer by the organization;
b. a CRI validation module configured for validating the CRI against a verification data corresponding to the customer, the verification data being stored at a server of the organization;
c. a communication module configured for electronically communicating a confirmation number to the customer, the confirmation number being communicated for authenticating the customer; and
d. a confirmation module configured for confirming the registration of the customer if the confirmation number is valid, wherein the confirmation number is entered by the customer at the EDC device.

11. The system according to claim 10 further comprising a number generation module configured for generating the confirmation number.

12. The system according to claim 10, wherein the EDC device comprises at least one of
a. an identity apparatus reader configured for reading the identity apparatus;
b. an input module for enabling the entry of at least one of the contact information, a Personal Identification Number (PIN) and the confirmation number; and
c. a display for providing a graphical user interface to the customer.

13. The system according to claim 12, wherein the display is further configured for displaying a plurality of messages indicating a current status of the registration.

14. The system according to claim 10, wherein the EDC device is at least one of an electronic Point of Sale (POS) terminal and an Automatic Teller Machine (ATM).

15. The system according to claim 10, wherein the contact information is at least one of a mobile phone number and an email address of the customer.

16. The system according to claim 10, wherein the information capturing module is further configured for fetching the verification data corresponding to the customer from the server of the organization.

17. The system according to claim 10, wherein the identity apparatus is at least one of a magnetic strip card, a contact-less card and a smart card.

18. The system according to claim 10, wherein the identity apparatus comprises the CRI.

19. The system according to claim 10, wherein the CRI includes at least one of a name of the customer, an account number of the customer, a customer identifier, an expiration date of the identity apparatus, a Personal Identification Number (PIN) Verification Value (PW), a PIN Verification Key Indicator (PVKI), a Card Verification Value (CVV) and a Card Validation Code (CVC).

20. The system according to claim 10, wherein the confirmation module is further configured for confirming the registration based on the validity of a Personal Identification Number (PIN), the PIN being provided to the customer by the organization for verifying the customer.

21. The system according to claim 20, wherein the PIN is entered by the customer at the EDC device and validated by the server of the organization.

22. The system according to claim 10, wherein the confirmation module is further configured for electronically communicating a message to the customer after the confirmation of the registration, the message indicating the confirmation of the registration.

23. The system according to claim 10, wherein the confirmation module is further configured for storing information corresponding to the registration of the customer.

24. The system according to claim 23, wherein the information being stored includes at least one of the date of the registration, a billing address, the contact information of the customer and the CRI.

25. A computer program product for use with a computer, the computer program product comprising a computer usable medium having a computer readable program code embodied therein for registering a customer with an organization for enabling the customer to avail one or more services through one or more delivery channels, the computer readable program code performing:
a. capturing Customer Relationship Information (CRI) and contact information of the customer through an Electronic Data Capture (EDC) device, the CRI being associated with an identity apparatus issued to the customer by the organization;
b. validating the CRI against a verification data corresponding to the customer, the verification data being stored at a server of the organization;
c. communicating a confirmation number to the customer if the CRI is valid, the confirmation number being communicated by the organization for authenticating the customer; and
d. confirming the registration of the customer if the confirmation number is valid, wherein the confirmation number is entered by the customer at the EDC device.

26. The computer program product according to claim 25, wherein the confirmation number is electronically communicated to the customer.

27. The computer program product according to claim 25, wherein the computer readable program code is further configured for fetching the verification data corresponding to the customer from the server of the organization.

28. The computer program product according to claim 25, wherein the computer readable program code is further configured for displaying a plurality of messages indicating a current status of the registration, wherein the plurality of messages is displayed on the EDC device.

29. The computer program product according to claim 25, wherein the computer readable program code is further configured for confirming the registration based on the validity of a Personal Identification Number (PIN) provided to the customer by the organization, the PIN being entered by the customer at the EDC device.

30. The computer program product according to claim 25, wherein the computer readable program code is further configured for electronically communicating a message indicating the confirmation of the registration to the customer.
